(19) United States
(12) Patent Application Publication
(10) Pub. No.: US 2010/0143682 A1
(43) Pub. Date: Jun. 10, 2010

(54) Mat-Faced Cementitious Article and Method for Preparing Same

(75) Inventors: Michael P. SHAKE, Johnsburg, IL (US); Qingxia LIU, Bloomington, IN (US); Salvatore C. IMMORDINO, Trevor, WI (US); Dick C. ENGBRECHT, Arlington Heights, IL (US); Donald L. ROELFS, West Burlington, IA (US); Christopher R. NELSON, Lindenhurst, IL (US); Wayne J. ROHRBAUGH, Dublin, OH (US); Joseph J. FEDORIS, Mediapolis, IA (US)

Correspondence Address: Leydig, Voit & Mayer, Ltd, 180 N. Stetson, Two Prudential Plaza, Suite 4900, Chicago, IL, 60601, US

(73) Assignee: United States Gypsum Company, Chicago, IL (US)

(21) Appl. No.: 12/608,619

(22) Filed: Oct. 29, 2009

Related U.S. Application Data
(60) Provisional application No. 61/109,886, filed on Oct. 30, 2008.

(51) Int. Cl. B32B 7/02; B05D 1/36; B05D 1/38

(52) U.S. Cl. 428/218; 427/403; 427/359

(57) ABSTRACT

A cementitious composite article comprising (a) a cementitious core, (b) a skim coat cementitious layer in contact with the cementitious core having a density greater than the cementitious core, and (c) a fibrous mat comprising (i) microfibers and (ii) continuous fibers having a length of about 0.6 cm or more, wherein the fibrous mat comprises an inner surface in contact with the skim coat cementitious layer; as well as a method for manufacturing same.

### CROSS-REFERENCE TO RELATED APPLICATION

This patent application claims the benefit of U.S. Provisional Patent Application No. 61/109,886, filed Oct. 30, 2008, which is incorporated by reference.

### TECHNICAL FIELD

The field relates to cementitious articles and, in particular, mat-faced gypsum boards and methods of making thereof.

### BACKGROUND OF THE INVENTION

Cementitious articles, such as gypsum board and cement board, are useful in a variety of applications, some of which require a degree of water resistance, including, for example, outdoor sheathing and roofing products. Traditional paper-faced cementitious articles do not always perform well under high moisture conditions, or upon exposure to the outdoors. Thus, for such applications, it is often desirable to use a cementitious article that is faced with a glass or polymer-based fibrous mat instead of paper. It also can also be advantageous to use additives in the cementitious core that improve the water resistance of the core material itself.

The manufacturing process of cementitious articles, such as gypsum board and cement board, typically involves depositing an aqueous cementitious slurry over a first facing material and covering the wet slurry with a second facing material of the same type, such that the cementitious slurry is sandwiched between the two facing materials. Thereafter, excess water is removed from the slurry by drying. The cementitious slurry is allowed to harden to produce a solid article prior to final drying.

Manufacturing cementitious articles using fibrous mats can be challenging due to the tendency of the aqueous cementitious slurry to seep or bleed-through the pores of the fibrous mat when the slurry is still in a liquid state. This bleed-through problem is especially noticeable at the point where the slurry is first deposited onto the fibrous mat.

Slurry bleed-through can lead to unwanted cementitious material on the outer surface of the fibrous mat and build-up of cementitious material on machine equipment. Cementitious material build-up on machine equipment used in the manufacturing process requires periodic machine shut down for cleaning because gypsum on the process equipment can transfer to the outer surface of the fibrous mat and/or lead to web tracking problems of the fibrous web into the forming head. Cementitious material on the outer surface of the mat can compromise the adherence of a finish coat and present an unpleasing appearance for the consumer.

Various attempts at preventing or minimizing slurry bleed-through have been suggested. Many of these attempts, however, require extra processing steps, incorporate additional materials, vary slurry characteristics to undesired ranges, specify the use of custom or non-standard fibrous mats, and/or increase the cost of the cementitious article.

Accordingly, there is a desire to provide a gypsum board and a method of making thereof having reduced and, preferably, minimal or no bleed-through of the gypsum slurry during manufacture of the gypsum board. These and other advantages of the present invention, as well as additional inventive features, will be apparent from the description of the invention provided herein.

### SUMMARY OF THE INVENTION

Provided herein is a mat-faced cementitious composite article comprising (a) a cementitious core, (b) a skim coat cementitious layer in contact with the cementitious core having a density greater than the cementitious core, and (c) a first fibrous mat comprising (i) microfibers and (ii) continuous fibers having an average length of about 0.6 cm or more, wherein the first fibrous mat comprises an inner surface in contact with the skim coat cementitious layer.

Also provided herein is a method of manufacturing a mat faced cementitious article comprising (a) providing a fibrous mat having an inner surface, wherein the mat comprises (i) microfibers and (ii) continuous fibers having a length of about 0.6 cm or more; (b) depositing an aqueous skim coat layer of cementitious slurry on the inner surface of the first fibrous mat; and (c) depositing an aqueous cementitious core slurry on top of the skim coat slurry to form a mat-faced cementitious composite article.

### DETAILED DESCRIPTION OF THE INVENTION

The present invention is predicated, at least in part, on the surprising and unexpected discovery of a mat-faced cementitious composite article, and method of manufacture thereof, comprising a cementitious core, a mat that includes continuous fibers of significant length in combination with microfibers, and a thin dense cementitious layer (“skim coat”), which composite advantageously provides sufficient strength and rigidity while reducing or avoiding unwanted “bleed-through” of the skim coat or cementitious core. In one aspect, the present invention reduces or eliminates the amount of unwanted cementitious slurry bleed through the fibrous mat, from either the cementitious core or the skim coat, without adding additional processing steps to a typical process of manufacturing cementitious board.

The cementitious core can comprise any material, substance, or composition containing or derived from hydraulic cement, along with any suitable additives. Non-limiting examples of materials that can be used in the cementitious core include Portland cement, sorrel cement, slag cement, fly ash cement, calcium alumina cement, water-soluble calcium sulfate anhydrite, calcium sulfate α-hemihydrate, calcium sulfate β-hemihydrate, natural, synthetic or chemically modified calcium sulfate hemihydrates, calcium sulfate dihydrate (“gypsum,” “set gypsum,” or “hydrated gypsum”), and mixtures thereof. As used herein, the term “calcium sulfate material” refers to any of the forms of calcium sulfate referenced above.

The skim coat layer has a density greater than that of the cementitious core, but can otherwise comprise any material, substance, or composition containing or derived from hydraulic cement, along with any additives, as described herein with respect to the cementitious core. The materials used in the skim coat can be the same or different from those used in the cementitious core, provided that the skim coat has a density greater than that of the cementitious core.

In one aspect, the composite cementitious article of the invention avoids the need for any deposition of discontinuous particulate or hydrophobic coating. See, e.g., commonly assigned, co-pending U.S. applications Ser. Nos. 11/738,316 and 12/176,200. While such particulate or coating is not included in some embodiments because of additional cost and/or complexity, they could be included if desired. It was unexpected that the fibrous mat comprising microfibers are sufficiently strong, e.g., with respect to nail pull resistance, tensile strength, rigidity, etc., to be used in the invention and further surprising that a skim coat could be included without bleed-through relative to the fibrous mat.

Embodiments of a fibrous mat-faced cementitious article according to the invention comprise (a) a cementitious core; (b) a skim coat layer; and (c) a first fibrous mat comprising continuous fibers of significant length and polymer or mineral (e.g., glass) microfibers. The first fibrous mat comprises an outer surface and an inner surface, the inner surface facing (e.g., in contact with) the cementitious core or, if present, the skim coat layer. Desirably, the cementitious core and/or skim coat of the composite article do not penetrate the first fibrous mat to any substantial degree during manufacture.

The continuous fibers of significant length and the microfibers can be made of any suitable material. The continuous fibers and/or microfibers can be biocompatible or biosoluble to enhance safety in certain applications. Examples of biosoluble microfibers are provided by U.S. Pat. Nos. 6,656,861, 6,794,321, and 6,828,264. In one aspect, the fibrous mat comprises glass fibers (e.g., biocompatible glass fibers) of significant length in combination with glass microfibers (e.g. biocompatible glass microfibers). However, the first fibrous mat can comprise other suitable types of polymer or mineral fibers and microfibers, or combinations thereof.

The continuous fibers of significant length can be provided by chopped strand fibers or other sources. The continuous fibers of significant length are preferably glass fibers (e.g., chopped glass fibers). Glass fibers of the E, C, and T type, as well as sodium borosilicate glasses, or mixtures of the foregoing, can be used. The continuous fibers can have varying lengths or substantially similar lengths.

Non-limiting examples of suitable microfibers include glass fibers, polyamide fibers, polyaramide fibers, polypropylene fibers, polyester fibers (e.g., polyethylene teraphthalate (PET)), polyvinyl alcohol (PVOH), polyvinyl acetate (PVAc), cellulosic fibers (e.g., cotton, rayon, etc.), and the like, as well as combinations thereof. Preferably, the microfibers are glass or mineral fibers, for example, mineral wool, slag wool, ceramic fibers, carbon fibers, metal fibers, refractory fibers, or mixtures thereof. One method of making microfibers is disclosed by U.S. Pat. No. 4,167,404.

Furthermore, the fibrous mat (e.g., the fibers of the mat) can be hydrophobic or hydrophilic, coated or uncoated. For applications that involve exposure to high levels of humidity, the mat desirably has a high level of hydrophobicity. Hydrophobicity can be imparted to the mat by coating the mat or the individual fibers of the mat, and/or using a hydrophobic binder, such as a styrene acrylic binder. Other methods of imparting hydrophobicity to the cementitious product also can be employed (e.g., adding a hydrophobing agent, like siloxane or wax, to the cementitious core and/or skim coat). In certain instances, however, it is desirable for the mat to be uncoated (e.g., no coating used in addition to the binder material), yet retain water resistant properties. Preferably, the mat exhibits water uptake of no more than three times the basis weight of the mat (e.g., when tested according to INDA standard test 10.1).

Of course, the choice of fibers will depend, in part, on the type of application in which the cementitious article is to be used. For example, when the cementitious article is used for applications that require heat or fire resistance, appropriate heat or fire resistant fibers should be used in the fibrous mat. In one embodiment, the fibrous mat has a melting point above 870° F. (e.g., 871° F. or higher, 880° F. or higher, 900° F. or higher, or even 1000° F. or higher). It is preferred that the mat facing is suitable to meet or exceed the standards for fire resistance set forth in NFPA Method 701 of the National Fire Protection Association or ASTM Standard E84, Class 1. More preferably, when the article is for use in such applications, the article comprising the cementitious core, skim coat, and fibrous mat as described herein meets or exceeds the standards for fire resistance set forth in ASTM C1177 or C1177M (e.g., using the E-119 test method).

The fibrous mat can be woven or non-woven; however, non-woven mats are preferred. Non-woven mats comprise fibers bound together by a binder. The binder can be any binder typically used in the mat industry. Suitable binders include, without limitation, urea formaldehyde, melamine formaldehyde, stearated melamine formaldehyde, polyester, acrylics, polyvinyl acetate, urea formaldehyde or melamine formaldehyde modified or blended with polyvinyl acetate or acrylic, styrene acrylic polymers, and the like, as well as combinations thereof. Preferably, the binder is a resin binder, such as a styrene acrylic binder. The resinous binder can have any suitable glass transition temperature (GTT) (e.g., about 15-45° C.) One example of a suitable styrene acrylate copolymer binder is HYCAR™ 26869 (Lubrizol Advanced Materials of Cleveland, Ohio). As delivered, this acrylate copolymer latex has a solids content of about 50 weight percent solids, but it is preferred to dilute the concentration with water to about 30 wt. percent solids before using it. Preferably up to about 10 weight percent of a crosslinker, such as melamine formaldehyde, is added to the acrylate; and more preferably about 2 to 5 weight percent of crosslinker is added. Any suitable amount of binder can be used. Typically, the fibrous mat will comprise about 20-40 percent (by dry weight), or 25-30 percent (by dry weight) of the binder (e.g., about 25.5-30.5 percent by dry weight).

The fibrous mat can have any suitable weight effective to prevent slurry bleed-through during manufacturing. Typically, the basis weight will be about 18 lbs/1000 ft² or greater (e.g., about 18-30 lbs/1000 ft²), equivalent to about 88 g/m² or greater (e.g., about 88-147 g/m²). In one embodiment, the fibrous mat, especially a glass fiber mat, has a basis weight of about 20 lbs/1000 ft² or greater (e.g., about 20-26 lbs/1000 ft², or about 23-26 lbs/1000 ft²), equivalent to about 98 g/m² or greater (e.g., about 98-127 g/m² or greater).

The microfibers of the fibrous mat can have any suitable diameter. The fibrous mat can comprise microfibers having a diameter, for instance, of about 0.05-6.5 microns, about 0.1-6 microns, about 0.25-5 microns, or about 1-4 microns, or even about 2-3 microns or 2.5-3.5 microns, such as about 2.7 microns (e.g., Micro-Strand® Type 481 available commercially from Johns Manville).

The fibrous mat also can comprise fibers having different diameters, for instance, diameters ranging from about 8 microns to about 25 microns. For example, the continuous fibers of significant length can have any suitable diameter, such as about 10 microns or greater (e.g., about 10-20 microns), about 13 microns or greater (e.g., about 13-17 microns), about 14 microns or greater (e.g., about 14-17 microns, about 14-16 microns, about 14.5-16.5 microns, or about 14.5-15.5 microns), or about 15 microns or greater (e.g., about 15-18 microns, 16-18 microns, 15-17 microns, or about 15-16 microns). Optionally, the fibrous mat also can comprise, in addition to or instead of continuous fibers having a diameter as described above, continuous fibers having a smaller diameter of at most about 13 microns.

The fibrous mat can comprise any suitable ratio of continuous fibers to microfibers effective to prevent slurry bleed-through during production. Preferably, the fibrous mat comprises a minor portion of microfibers or small diameter fibers (e.g., 13 microns or less), and a major portion of continuous fibers other than microfibers, such as the continuous fibers of significant length described herein. Such minor portion can be, for instance, about 5-30 percent (e.g., about 10-25 percent) or about 15-30 (e.g., about 15-20 percent) of the dry fibrous web, and the major portion being about 70-95 percent (e.g., about 75-90 percent) or 70-85 percent (e.g., about 80-85 percent) of the dry fibrous web. According to certain embodiments, the fibrous mat comprises about 70 to about 95 percent, such as about 80 to about 95 percent, or even about 85 to about 90 percent continuous fibers, and about 5 to about 30 percent, such as about 5 to about 20 percent, or about 10 to about 15 percent (e.g., the remainder) microfibers. Thus, for example, the fibrous mat can comprise about 70 to about 95 percent continuous fibers (e.g, continuous glass fibers) having a diameter of about 10 to about 20 microns, and about 5 to about 30 percent microfibers (e.g., glass microfibers) having a smaller diameter as described herein. In another embodiment, the fibrous mat can comprise about 70 to about 90 percent continuous fibers (e.g., continuous glass fibers) having a diameter of about 14 microns or greater, or 15 microns or greater (e.g., about 14 to about 17 microns, about 14 to about 16 microns, or about 14.5 to about 15.5 microns) and about 10 to about 30 percent microfibers (e.g., glass microfibers) having a smaller diameter as described herein. Unless otherwise specified, the percent fiber compositions are referenced by weight of the fiber content of the mat (i.e., by dry weight of the fibrous web).

The fibers can have any suitable length, provided the continuous fibers have a length of about 0.6 cm or more, or about 1 cm or more. The continuous fibers typically will have a length of about 1 inch or less (e.g., about 3 cm or less, or about 2.5 cm or less). Thus, the continuous fibers can have an average length, for example, in the range of about 0.6 to 1.9 cm, or about 0.6 to about 1.2 cm. Alternatively, the continuous fibers can have an average length in the range of about ⅜-inch to 1 inch (about 1 cm to about 3 cm), or about ½-inch to about ¾-inch (about 1 cm to about 2 cm). The microfibers can be of varying lengths. For instance, the microfibers can have lengths ranging from a few times their diameter up to a length of 7 mm or more, or even 12 mm or more. According to one embodiment, the microfibers have a length of less than about 7 mm.

By way of further illustration, a non-limiting example of a suitable glass fiber mat comprises about 80-90 percent (e.g., about 83 percent) 16 micron diameter, ½-inch to 1-inch long (about 1.2-2.5 cm long) continuous filament fibers and about 10-20 percent (e.g., about 17 percent) biosoluble microfibers having about 2.7 nominal micron diameter (Micro-Strand® Type 481, manufactured by Johns Manville) with a basis weight of about 24 lbs/1000 ft². One suitable glass fiber mat is the DuraGlass® 8924G Mat, manufactured by Johns Manville. The binder for the glass mat can be any suitable binder, for example, styrene acrylic binder, which can be about 28% (+/−3%) by weight of the mat. The glass mat can include a colored pigment, for example, green pigment or colorant.

Fiber lengths and diameters, as referred to herein, are average lengths and diameters unless otherwise specified.

The fibrous mats optionally can comprise fillers, pigments, or other inert or active ingredients typically used. For example, the mat can comprise effective amounts of fine particles of limestone, glass, clay, coloring pigments, biocide, fungicide, intumescent material, or mixtures thereof. Such additives can be useful to alter the coloration, modify the structure or texture of the surface, improve resistance to mold or fungus formation, and enhance fire resistance. For certain applications, flame retardants sufficient to provide flame resistance, e.g. according to NFPA Method 701 of the National Fire Protection Association or ASTM Standard E84, Class 1, are added. Also, for certain applications, biocide is preferably added to the mat and/or gypsum slurry to resist fungal growth, measurable in accordance with ASTM Standard D3273.

Desirably, the fibrous mat has sufficient air permeability to facilitate drying of the cementitious article while reducing or eliminating bleed-through of the cementitious slurry or skim coat during manufacture. Air permeability of a mat can be determined, for instance, using the Frazier test described by ASTM Standard Method D737, with the results ordinarily being given in units of cubic feet per minute per square foot (cfm/ft²). The test may be carried out at a differential pressure of about 0.5 inches of water. In certain embodiments, the permeability of fibrous mat of the cementitious article, as measured by the Frazier method, is about 250-400 cfm/ft², about 250-350 cfm/ft² or even about 250-300 cfm/ft² (e.g., about 1270-2020 L/s/m³, about 1270-1770 L/s/m³, or about 1270-1530 L/s/m³). In another embodiment, the permeability of the fibrous mat is desirably less than about 300 cfm/ft² (e.g., about 250 cfm/ft² to less than about 300 cfm/ft²), or about 1530 L/s/m³ (e.g., about 1270 L/s/m³ to less than about 1530 L/s/m³). In other embodiments, the fibrous mat comprises pores having an average pore size of about 80 to 150 microns.

The fibrous mat can be manufactured using routine techniques, as described, for example, in U.S. Pat. No. 4,129,674.

According to a preferred aspect of the invention, the first fibrous mat is not substantially embedded in the cementitious core. Preferably, less than about 50% of the thickness of the mat is embedded in the cementitious core, more preferably less than about 30%, less than about 15%, less than about 10%, or even less than about 2% (e.g., less than about 1%) of the thickness of the mat is embedded in the cementitious core.

The cementitious article optionally can comprise a second fibrous mat comprising polymer or mineral fibers, wherein the cementitious core and skim coat, when present, is disposed between the first fibrous mat and the second fibrous mat. The cementitious article further can comprise a second fibrous mat and second skim coat, wherein the second fibrous mat is in contact with the second skim coat, and the second skim coat is in contact with the cementitious core (e.g., the cementitious core is disposed between the first and second skim coats, and the first and second skim coats having the cementitious core disposed therebetween is disposed between the first and second fibrous mats. The second fibrous mat can be the same or different from the first fibrous mat. When the cementitious article is in the form of a board or panel (e.g., gypsum board, cement board, etc.), the second fibrous mat is preferably the same as the first fibrous mat, both in material and orientation relative to the cementitious core, or has sufficiently similar expansion and contraction properties to the first fibrous mat, such that warping of the cementitious article is reduced or eliminated. When the second fibrous mat is the same as the first fibrous mat, it should be understood that the first and second fibrous mats can be provided by a single continuous piece of material, for example, by folding a single piece of fibrous mat such that it wraps around the cementitious core.

The core and skim coat layers can comprise any suitable additives. The additives can be any additives commonly used to produce cementitious articles, such as gypsum board or cement board. Such additives include, without limitation, structural additives such as mineral wool, continuous or chopped glass fibers (also referred to as fiberglass), perlite, clay, vermiculite, calcium carbonate, polyester, and paper fiber, as well as chemical additives such as foaming agents, fillers, accelerators, sugar, enhancing agents such as phosphates, phosphonates, borates and the like, retarders, binders (e.g., starch and latex), colorants, fungicides, biocides, and the like. Examples of the use of some of these and other additives are described, for instance, in U.S. Pat. Nos. 6,342,284, 6,632,550, 6,800,131, 5,643,510, 5,714,001, and 6,774,146, and U.S. Patent Publications 2004/0231916 A1, 2002/0045074 A1 and 2005/0019618 A1.

Preferably, the cementitious core comprises a calcium sulfate material, Portland cement, or mixture thereof. The cementitious core can also comprise a hydrophobic agent, such as a silicone-based material (e.g., a silane, siloxane, or silicone-resin matrix), in a suitable amount to improve the water resistance of the core material. The cementitious core can also comprise a siloxane catalyst, such as magnesium oxide (e.g., dead burned magnesium oxide), fly ash (e.g., Class C fly ash), or a mixture thereof. The siloxane and siloxane catalyst can be added in any suitable amount, and by any suitable method, for instance, as described, for example, in U.S. Patent Publications 2006/0035112 A1, 2007/0022913 A1, or 2008/0190062. Desirably, the cementitious core also comprises strength-improving additives, such as phosphates (e.g., polyphosphates as described in U.S. Pat. Nos. 6,342,284, 6,632,550, and 6,800,131 and U.S. Patent Publications 2002/0045074 A1, 2005/0019618 A1, and 2007/0022913 A1) and/or pre-blended unstable and stable soaps (e.g., as described in U.S. Pat. Nos. 5,683,635 and 5,643,510). The cementitious core can comprise paper or glass fibers, but is preferably substantially free of paper and/or glass fibers (e.g., comprises less than about 1 wt. %, less than about 0.5 wt. %, less than about 0.1 wt. %, or even less than about 0.05 wt. % of paper and/or glass fibers, or contains no such fibers).

When used for applications that involve exposure to high humidity, it may be desirable for the cementitious article to meet the water-resistance standards set forth in ASTM C1177, for instance, the 2-hour immersion target for sheathing without board defects of 10% and for water resistant gypsum backing board of 10% using ASTM Standard Test Method C 473. Thus, it may be desirable for the cementitious article to comprise one or both of a fibrous mat that exhibits a high level of humidity resistance, as described herein, and a cementitious core material comprising a hydrophobing agent, also as described herein.

The cementitious article can be of any type or shape suitable for a desired application, whether interior or exterior. Non-limiting examples of cementitious articles include gypsum panels and cement panels or boards of any size and shape. For example, the cementitious article can be for an outdoor sheathing or roofing product of any suitable configuration, or for use in walls and ceilings, or underlayments for floors.

Non-limiting embodiments of the cementitious articles of the invention include, for instance, a gypsum board, comprising (a) a gypsum layer comprising a cementitious core and at least one skim coat layer in contact with the cementitious core, the gypsum layer having a first face and a second face and comprising set gypsum; (b) first and second facers affixed to said first and second faces, said first facer being an uncoated fibrous mat comprising a non-woven web bonded together with a resinous binder, and said web comprising glass fiber consisting essentially of a blend of a major portion of chopped glass fibers having an average fiber diameter of at least about 16 microns and a minor portion consisting essentially of at least one of small diameter glass fibers having a fiber diameter of at most about 13 microns, and microfibers having an average fiber diameter ranging from about 0.05 to about 6.5 microns, said minor portion comprising about 5-30 percent of the dry weight of the web. The gypsum board may be further configured such that said second facer is a fibrous mat comprising a non-woven web bonded together with a resinous binder, and said web comprising glass fiber consisting essentially of a blend of a major portion of chopped glass fibers having an average fiber diameter of at least about 16 microns and a minor portion consisting essentially of at least one of small diameter glass fibers having a fiber diameter of at most about 13 microns, and microfibers having an average fiber diameter ranging from about 0.05 to about 6.5 microns, said minor portion comprising about 5-30 percent of the dry weight of the web.

According to other aspects of the embodiment, the major portion of fibers consists essentially of about 85% by weight of glass fiber having an average diameter of about 16 microns and an average fiber length of about 13-19 mm, and said minor portion consists essentially of about 15% by weight of microfibers, substantially all of which have a diameter in the range from about 2.7 to 3.4 microns. Or, said major portion of fibers consists essentially of about 65-75% by weight of glass fiber having an average diameter of about 16 microns and an average fiber length of about ½″, and about 15-20% by weight of glass fiber having an average diameter of about 16 microns and an average fiber length of about 1″, and said minor portion consists essentially of about 15-25% by weight of microfibers, substantially all of which have a diameter in the range from about 2.7 to 3.4 microns. Alternatively, said major portion consists essentially of about 80% by weight of chopped glass fiber having an average diameter of about 16 microns and an average fiber length of about 0.5 inch and said minor portion consists essentially of about 20% by weight of small glass fiber having an average diameter of about 11 microns and an average fiber length of about 0.25 inch. In yet another aspect, said major portion consists essentially of about 68% by weight of chopped glass fiber having an average diameter of about 16 microns and an average fiber length of about 0.5 inch and about 17% by weight of chopped glass fiber having an average diameter of about 16 microns and an average fiber length of about 1 inch, and said minor portion consists essentially of about 20% by weight of microfibers, substantially all of which have a diameter in the range from about 2.7 to 3.4 microns.

In another non-limiting example, the cementitious article is a gypsum board, comprising (a) a gypsum layer having a first face and a second face and comprising set gypsum, said gypsum layer comprising at least one skim coat layer in contact with a cementitious core layer and having a density greater than the cementitious core layer; and (b) first and second facers affixed to said first and second faces, said first facer being an uncoated fibrous mat comprising a non-woven web bonded together with a resinous binder consisting essentially of a styrene acrylic copolymer binder, and said web comprising glass fiber consisting essentially of a major portion of chopped glass fibers having an average fiber diameter ranging from about 8 to 25 microns, and optionally a minor portion consisting essentially of at least one of small diameter glass fibers having a fiber diameter of at most about 13 microns, and microfibers having an average fiber diameter ranging from about 0.05 to about 6.5 microns. According to this embodiment, the web can comprise glass fiber consisting essentially of a blend of said major portion of chopped glass fibers and said minor portion, and said major portion comprises at least 50 percent of the dry weight of the web. In another aspect, the major portion of chopped glass fibers consists essentially of fibers having an average fiber diameter of at least about 16 microns.

In any of the foregoing exemplary embodiments, the mat preferably absorbs no more than three times its weight in water according to INDA Test 10.1, and the binder can be any suitable resinous binder described herein, especially a styrene acrylic binder optionally comprising a crosslinker as described herein.

The cementitious article can be prepared by any suitable method including, but not limited to, the inventive methods described herein. Embodiments of a method of preparing a fibrous mat-faced cementitious article according to the invention comprise (a) providing a fibrous mat having an inner surface, wherein the fibrous mat comprises (i) microfibers and (ii) continuous fibers having a length of about 0.9-3 cm; (b) depositing an aqueous skim coat layer of cementitious slurry on the inner surface of the first fibrous mat; and (c)depositing an aqueous cementitious core slurry on top of the skim coat slurry to form a mat-faced composite article. The method can comprise further steps to form the mat-faced composite article into a desired form or shape (e.g., board) suitable for a particular end use (e.g., sheathing or roofing).

The method of preparing a cementitious article in accordance with the invention can be conducted on existing gypsum board manufacturing lines used to make fibrous mat-faced cementitious articles known in the art. Briefly, the process typically involves discharging a fibrous mat material onto a conveyor, or onto a forming table that rests on a conveyer, which is then positioned under the discharge conduit (e.g., a gate-canister-boot arrangement as known in the art, or an arrangement as described in U.S. Pat. Nos. 6,494,609 and 6,874,930) of a mixer. The components of the cementitious slurry are fed to the mixer comprising the discharge conduit, where they are agitated to form the cementitious slurry. Foam can be added in the discharge conduit (e.g., in the gate as described, for example, in U.S. Pat. Nos. 5,683,635 and 6,494,609). The cementitious slurry is discharged onto the fibrous mat facing material. The slurry is spread, as necessary, over the fibrous mat facing material and optionally covered with a second facing material, which may be a fibrous mat or other type of facing material (e.g., paper, foil, plastic, etc.). The wet cementitious assembly thereby provided is conveyed to a forming station where the article is sized to a desired thickness, and to one or more knife sections where it is cut to a desired length to provide a cementitious article. The cementitious article is allowed to harden, and, optionally, excess water is removed using a drying process (e.g., by air-drying or transporting the cementitious article through a kiln). Each of the above steps, as well as processes and equipment for performing such steps, are known in the art.

The skim coat is provided between the facing material and the core slurry. For example, the thin, dense layer of cementitious slurry can be deposited on the fibrous mat facing material before depositing the core slurry onto the thin, dense skim coat layer. When a second facing material is used, which may be the same or different from the first facing material, a second skim coat layer can, for instance, be deposited onto the facing material and the second facing material comprising the second skim coat brought into contact with the cementitious core slurry so that the second skim coat is in contact with the cementitious core slurry. The skim coat adds physical properties to the composite board, such as strength, as well as enhancing adherence of the core to the mat and improving fire resistance. It is particularly surprising and unexpected that the skim coat can be included in the present invention with reduced or no bleed-through relative to the mat. Prior to the invention, there was a concern with skim coat because it was believed to exacerbate bleed-through.

The equipment and process for forming the skim coat is generally known in the field of drywall manufacture. The cementitious material in the skim coat is dense relative to the core cementitious slurry. Thus, foam in the skim coat slurry can be mechanically beaten out as with one or more secondary mixers, and/or can be chemically treated with a defoamer, in some embodiments as is known in the art. In other embodiments, the cementitious slurry is separated into skim coat slurry and core slurry, with foam being inserted into the core slurry, or the skim coat slurry is otherwise formed in the absence of foam, e.g., by inserting foam into the core slurry outside the mixer in a discharge conduit or through a multiple mixer arrangement. In some embodiments, some foam is added to the skim coat slurry, albeit less foam than is added to the core slurry, particularly where edges are formed from the skim coat slurry to avoid having edges that are too hard, as is known in the art. See, e.g., U.S. Pat. Nos. 5,198,052; 5,714,032; 5,718,797; 5,879,486; 5,908,521; 6,494,609; 6,742,922; US 2004/013458A1; and U.S. patent application Ser. No. 12/415,931.

In order to further reduce bleed-through during production, the viscosity of the skim coat can be increased as compared to the production of interior, residential drywall board of the same thickness on a given manufacturing line or same type of manufacturing line. For example, the viscosity of the skim coat can be increased by about 2% or more, about 3% or more, about 4% or more, or even about 5% or more (e.g., about 7% or more, about 8% or more, about 10% or more, about 15% or more, or even about 20% or more) as compared to that used in the production of interior, residential drywall board of the same thickness on a given manufacturing line or same type of manufacturing line. According to certain embodiments, the skim coat can have a viscosity such that, when measured by the slump test, the skim coat slurry will produce a patty having a diameter of about 9″ or less (e.g., about 8.75″ or less, about 8.5″ or less, or about 8.25″ or less), preferably about 8″ or less (e.g., about 7.75″ or less, about 7.5″ or less, or about 7.25″ or less), or even about 7″ or less (e.g., about 6.75″ or less, about 6.5″ or less, or about 6.25″ or less). Alternatively, the diameter of the patty can be about 23 cm or less (e.g., about 22.5 cm or less, about 22 cm or less, or about 21.5 cm or less), about 21 cm or less (e.g., about 20.5 cm or less, about 20 cm or less, or about 19.5 cm or less), about 19 cm or less (e.g., about 18.5 cm or less, about 18 cm or less, or about 17.5 cm or less) or even about 17 cm or less (e.g., about 16.5 cm or less or about 16 cm or less). Typically, the viscosity will be such as to produce a patty of about 5″ or more (e.g., about 12 or 12.5 cm or more), such as about 5.5″ or more (e.g., about 14 cm or more) or about 6″ or more (e.g., about 15 cm or more). Procedures for measuring the viscosity of a slurry using the slump test are known in the art. Briefly, a 2″ (or 5 cm) diameter tube (e.g., with two open ends, one resting on a flat, substantially non-porous surface so as to block the opening) is filled with slurry to a height of 4″ (10 cm). Within 5 seconds from sampling the slurry from the manufacturing line, the slurry is released onto a flat, level surface by quickly lifting the cylinder, and the released slurry is allowed to spread into a patty. When the slurry has stopped spreading, the widest diameter of the slurry patty is measured (in the case of non-circular (e.g., elliptical) slurry patty, the widest diameter of the slurry patty is averaged with the diameter of the slurry patty in the direction perpendicular to the widest diameter).

Such changes in viscosity can be achieved, for example, reducing water content to thereby thicken the skim coat slurry. In addition, or alternatively, foam can be introduced into the skim coat to increase viscosity and/or reduce density. This relatively thicker slurry advantageously facilitates reducing or avoiding bleed-through. For example, it is believed that the relatively thicker slurry in the skim coat influences the flow and momentum of the skim coat slurry stream to reduce or avoid bleed-through, i.e., slurry penetration of the mat. Density can be adjusted to reduce or eliminate slurry penetration, provided that sufficient density is maintained in the skim coat so that the skim coat is more dense than the cementitious slurry and, desirably, imparts one or more of the desirable properties of the skim coat described herein. The density also can be adjusted to optimize edge hardness, especially where the edges are formed from the skim coat slurry, to avoid blowout during installation, e.g., when the edges are screwed to framing members, as one of ordinary skill in the art will readily recognize. The precise density may vary depending on purity of the cementitious material (e.g., stucco) or other raw material properties.

Also, the skim coat can be applied, optionally, by extracting skim coat slurry from the mixer at lower velocity as compared to that used in the production of interior, residential drywall board of the same thickness on a given manufacturing line or same type of manufacturing line. This can be achieved, for instance, by reducing the volume of slurry in the extraction hose or increasing the diameter of the extraction hose or by increasing the diameter of the extraction hose.

The skim coat layer can be of any suitable thickness. For example, in some embodiments, the thickness can vary from about 1/16 inch to about ⅛ inch. Also, hard edges, as known in the art, are sometimes used in a manner well known to one of ordinary skill in the art. Hard edges refer to the use of a more dense layer of cementitious slurry around the perimeter of a board-shaped cementitious article. The hard edges can be formed by the skim coat slurry itself.

The application of the skim coat layer can involve the use of one or more skim coat rollers to distribute and/or flatten the skim coat to a desired thickness. The inventors have also surprisingly found that, in some embodiments, the rotational speed of the rollers used in applying the skim coat during manufacture lessens bleed through of the skim coat and/or cementitious core slurry. In some embodiments, the rotational speed of the roller is reduced as compared to that used in the production of interior, residential drywall board of the same thickness on a given manufacturing line or same type of manufacturing line to facilitate further reduction or avoidance of bleed-through. Thus, the method of the invention can further comprise a step of rolling the skim coat with a skim coat roller prior to depositing the cementitious core slurry, wherein the roller has a reduced rotational speed as compared to that used in the production of interior, residential drywall board of the same thickness on a given manufacturing line or same type of manufacturing line. The roller speed can be reduced by any amount effective to reduce the amount of bleed-through of the core slurry or skim coat as compared to the amount of bleed-through that occurs in the absence of roller speed reduction. The degree of bleed-through can be measured by any suitable method, such as by measuring the weight or volume of core slurry or skim coat that penetrates the mat facing per unit area of the cementitious article, or by examining a cross-section of the cementitious article and measuring the thickness of the mat facing penetrated by the core slurry or skim coat. By way of illustration, the roller speed can be reduced as compared to that used in the production of interior, residential drywall board of the same thickness on a given manufacturing line or same type of manufacturing line by about 10% or more, about 15% or more, about 20% or more, about 25% or more, about 30% or more, about 40% or more, about 50% or more, or even about 75% or more. The exact speed may vary depending on the manufacturing line and size of the roller used. By way of example, the skim coat roller might have a roller speed of 130 feet per minute (fpm) or less, such as about 95 fpm or less, about 80 fpm or less, about 65 fpm or less, about 50 fpm or less, or even about 35 fpm or less (e.g., about 40 meters per minute (mpm) or less, about 30 (mpm) or less, about 25 (mpm) or less, about 20 (mpm) or less, about 15 (mpm) or less, or about 10 (mpm) or less). The skim coat roller typically has a diameter of about 4-8,″ such as about 4″, 5″, 6″, or 7″ (e.g., 0.1 m, 0.13 m, 0.15 m, 0.18 m, 0.2 m). Thus, in some embodiments (assuming a roller diameter of about 6″), the skim coat roller rotates at a rotational speed of no more than about 80 rpm , such as no more than about 60 rpm (e.g., within a range of about 50-60 rpm, or even about 52-57 rpm). In other embodiments, the roller speed might be slower, such as about 15-20 rpm. Such a speed is significantly reduced as compared, for example, to roller speeds of 185-200 rpm that might be used in the production of interior, residential drywall board of the same thickness on a given manufacturing line or same type of manufacturing line.

In some embodiments, the production of cementitious articles optionally can include vibration of the cementitious article prior to hardening to facilitate reduction or elimination of voids in the cementitious slurry, if desired, such as through the use of known vibration bars or other vibration equipment. Vibration optionally may be turned off, if desired, to further facilitate reducing or preventing bleed-through. Thus, the method of the invention optionally is performed without the use of vibrational equipment. In this sense, vibrational equipment is any machinery designed or employed for the purpose of producing vibration. It is recognized that manufacturing equipment having other primary purposes may produce some level of vibration as a side-effect of its normal operation. However, such equipment having primary functions other than producing vibrations is not considered vibrational equipment.

All aspects of the first fibrous mat used in accordance with the method of preparing a cementitious article are as described herein with respect to the cementitious article of the invention.

The cementitious slurry preferably does not substantially penetrate the first fibrous mat, thereby preventing the first fibrous mat from embedding in the cementitious slurry to any substantial degree. Preferably, the cementitious slurry penetrates less than about 50% of the thickness of the mat, more preferably less than about 30%, less than about 15%, less than about 10%, or even less than about 2% (e.g., less than about 1%) of the thickness of the mat.

Optionally, the method of preparing a fibrous mat-faced cementitious article can further comprise contacting the cementitious slurry with a second fibrous mat prior to allowing the cementitious slurry to harden, wherein the cementitious slurry is disposed between the first fibrous mat and the second fibrous mat. As described above, skim coat slurry can optionally be applied to the second fibrous mat and the second fibrous mat combined with the first fibrous mat, first skim coat, and cementitious core such that the second skim coat is in contact with the cementitious core. All other aspects of the first and second fibrous mats are as described with respect to the cementitious article of the invention.

The cementitious slurry comprises any of the cementitious materials and additives previously described as suitable or preferred with respect to the cementitious core of the cementitious article, along with sufficient water to provide a suitable viscosity. When measured by the slump test, the cementitious slurry will typically produce a patty with a diameter of about 5″ to about 8″ (or about 10 cm to about 20 cm), such as about 5″ to 7″ or about 6″ to about 7″ (or about 15 cm to about 18 cm). Procedures for measuring the viscosity of a slurry using the slump test are known in the art. Briefly, a 2″ (or 5 cm) diameter tube (e.g., with two open ends, one resting on a flat, substantially non-porous surface so as to block the opening) is filled with slurry to a height of 4″ (10 cm). Within 5 seconds from sampling the slurry from the manufacturing line, the slurry is released onto a flat, level surface by quickly lifting the cylinder, and the released slurry is allowed to spread into a patty. When the slurry has stopped spreading, the widest diameter of the slurry patty is measured (in the case of non-circular (e.g., elliptical) slurry patty, the widest diameter of the slurry patty is averaged with the diameter of the slurry patty in the direction perpendicular to the widest diameter).

Other aspects of the method of preparing a fibrous mat-faced cementitious article are as described herein with respect to the cementitious article of the invention. Those aspects of the method of preparing a fibrous mat-faced cementitious article not specifically described herein can be supplied by the techniques known and used in the manufacture of conventional cementitious articles, especially fibrous mat-faced cementitious articles.

The cementitious core slurry can include a water-resistant additive as are known in the art. For example, in some embodiments, the core cementitious slurry can include a siloxane suitable for conferring water-resistance to a cementitious mixture can be used. In some embodiments, the siloxane is provided in an aqueous siloxane dispersion comprising about 4 wt. % to about 8 wt. % siloxane in water. See, e.g., U.S. patent application Ser. No. 11/738,316. The siloxane can be a cyclic hydrogen-modified siloxane or, preferably, a linear hydrogen-modified siloxane. The siloxane is desirably a liquid (e.g., a siloxane oil).

In some embodiments, the dispersion is stabilized, such that the siloxane droplets remain dispersed in the water (i.e., the siloxane phase does not substantially separate from the water phase) for a period of time sufficient to allow the dispersion to be combined with the other components of the cementitious core.

All other aspects of the method of preparing a water-resistant cementitious article are as described herein with respect to the fibrous mat-faced cementitious article or the method of preparing a mat-faced cementitious article. Aspects of the method of preparing water-resistant cementitious article not specifically described herein can be supplied by the techniques known and used in the manufacture of conventional cementitious articles, especially fibrous mat-faced cementitious articles.

### Example 1

The following example illustrates the preparation of a fibrous-mat faced cementitious article in accordance with the invention.

The fibrous mat used is a DuraGlass® 8924G Mat, manufactured by Johns Manville.

A cementitious slurry is prepared in a board mixer. Example formulations are provided in Tables 1A and 1B and 2A and 2B. The siloxane component of the slurry is dispersed in water using a high shear mixer (e.g., Ross Sanitary Design High Shear Incline Mixer, Model ME-440XS-9 type homogenizer), and introduced into the gauging water used to prepare the slurry.

The face fibrous mat is positioned for application to the face (formed down) and the back (formed up) of the cementitious panel. The mat is passed through a tensioning and alignment system, and the face mat is creased to form the desired thickness (e.g., ⅝″) and desired edge (e.g., square) at the desired board width (e.g., 48″).

A dense layer of cementitious slurry or skim coat is deposited on the face mat. The cementitious slurry used for the skim coat or skim coat slurry is extracted from the board mixer. The skim coat slurry extraction velocity is reduced by reducing the volume of slurry in the extraction hose and the water near the point of extraction of the skim coat slurry is also reduced. The rotational speed of the skim coat roller is reduced (e.g. to about 52-57 rpm). See, e.g., Table 3 showing example operating parameters of a skim coat system.

Vibration apparatuses are turned off to help reduce slurry penetration through the mat.

The face mat is passed under the board mixer, and the cementitious slurry is deposited onto the dense layer or skim coat.

The creased face mat with the slurry in-place is formed into an envelope and passed under the forming plate. At the point where the formed face mat enters the forming plate, the back mat is placed in contact with the edges of the face mat. A bead of adhesive is used to bond the face glass mat to the back glass mat at the point where the mats intersect. Slurry does not contact the face and back glass mats at this intersection.

The completed glass mat envelope, filled with slurry, exits the forming plate and is transferred to the board belt. Guides keep the edges in the proper position until the slurry hydrates at a point about 30 seconds down the board belt, at which point the edges are self-supporting. The board is moved further down the line until it becomes self supporting. Thereafter, the board is cut to slightly longer than its desired finished length with a board knife. The board is inverted and moved into the kiln to remove the excess water (e.g., for 40 minutes).

The board is then arranged face-to-face or face-to-back and cut to the desired length. The resulting product is a fibrous mat-faced cementitious product.

As an alternative, non-limiting embodiment, the cementitious article is an article comprising a hydraulic set material layer having first and second faces, and first and second facers affixed thereto, and is provided by a process comprising (a) forming an aqueous slurry comprising at least one member selected from the group consisting of anhydrous calcium sulfate, calcium sulfate hemi-hydrate, and hydraulic setting cement; (b) distributing the slurry to form a layer on said first facer; (c) applying said second facer onto the top of said layer; (d) separating the resultant laminate into individual articles; and (e) drying the articles, wherein at least one of the facers is an uncoated fibrous mat comprising a non-woven web bonded together with a resinous binder consisting essentially of a styrene acrylic binder, and said web comprising glass fiber consisting essentially of a major portion of chopped glass fibers having an average fiber diameter ranging from about 8 to 25 microns and, optionally, a minor portion consisting essentially of at least one of small diameter glass fibers having a fiber diameter of at most about 13 microns, and microfibers having an average fiber diameter ranging from about 0.05 to about 6.5 microns.

All other aspects of the method of preparing the cementitious article are as described herein with respect to the cementitious article itself.

TABLE 1A
⅝″ Production

| | Averages | Stan Dev |
|---|---|---|
| STUCCO (lbs./MSF) | 2208.04 | 9.08 |
| GAUGING_WATER (lbs./MSF) | 888.89 | 9.63 |
| FOAM_WATER (lbs./MSF) | 95.08 | 1.50 |
| FOAM_AIR | 14.59 | 0.83 |
| SOAP (lbs./MSF) | 0.57 | 0.06 |
| GROUND GYPSUM | 7.40 | 0.02 |
| ACCELERATOR | | |
| (5% wt. % sugar) (lbs./MSF) | | |
| DISPERSANT (lbs./MSF) | 5.06 | 0.69 |
| RETARDER (lbs./MSF) | 0.15 | 0.00 |
| TOTAL_WATER (lbs./MSF) | 1462.12 | 10.50 |
| WATER_STUCCO_RATIO (%) | 66.20 | 0.58 |
| SODIUM TRIMETAPHOSPHATE | 1.10 | 0.01 |
| (dry lbs./MSF) | | |
| SILOXANE (lbs./MSF) | 10.00 | 0.04 |
| FLYASH (lbs./MSF) | 8.01 | 0.33 |
| MGO (lbs./MSF) | 1.00 | 0.05 |
| BIOCIDE (lbs./MSF) | 0.99 | 0.04 |

TABLE 1B
½″ Production

| | Averages | Stan Dev |
|---|---|---|
| STUCCO (lbs./MSF) | 1769.21 | 5.82 |
| GAUGING_WATER (lbs./MSF) | 740.98 | 3.17 |
| FOAM_WATER (lbs./MSF) | 83.17 | 0.52 |
| FOAM_AIR | 12.52 | 0.14 |
| SOAP (lbs./MSF) | 0.45 | 0.04 |
| GROUND GYPSUM | 6.86 | 0.10 |
| ACCELERATOR | | |
| (5% wt. % sugar) (lbs./MSF) | | |
| DISPERSANT (lbs./MSF) | 2.91 | 0.13 |
| RETARDER (lbs./MSF) | 0.20 | 0.00 |
| TOTAL_WATER (lbs./MSF) | 1135.37 | 3.11 |
| WATER_STUCCO_RATIO (%) | 64.21 | 0.27 |
| SODIUM TRIMETAPHOSPHATE | 1.65 | 0.00 |
| (dry lbs./MSF) | | |
| SILOXANE (lbs./MSF) | 9.62 | 0.49 |
| FLYASH (lbs./MSF) | 8.01 | 0.12 |
| MGO (lbs./MSF) | 0.97 | 0.06 |
| BIOCIDE (lbs./MSF) | 1.00 | 0.01 |

TABLE 2A
⅝″ Production

| | Averages | Stan Dev |
|---|---|---|
| STUCCO (lbs./MSF) | 2285.58 | 11.19 |
| GAUGING_WATER (lbs./MSF) | 1527.52 | 2.01 |
| FOAM_WATER (lbs./MSF) | 53.65 | 0.11 |
| FOAM_AIR | 7.63 | 1.09 |
| SOAP (lbs./MSF) | 0.21 | 0.02 |
| GROUND GYPSUM | 8.43 | 0.76 |
| ACCELERATOR | | |
| (5% wt. % sugar) (lbs./MSF) | | |
| FLYASH (lbs./MSF) | 7.74 | 0.70 |
| DISPERSANT (lbs./MSF) | 9.84 | 1.26 |
| RETARDER (lbs./MSF) | 0.34 | 0.04 |
| MgO (lbs./MSF) | 2.76 | 0.35 |
| TOTAL_WATER (lbs./MSF) | 1599.43 | 6.93 |
| WATER_STUCCO_RATIO (%) | 69.99 | 0.16 |
| SODIUM TRIMETAPHOSPHATE | 1.05 | 0.02 |
| (dry lbs./MSF) | | |
| SILOXANE (lbs./MSF) | 9 to 10 | |
| BIOCIDE (lbs./MSF) | 1.00 | |

TABLE 2B
½″ Production

| | Averages | Stan Dev |
|---|---|---|
| STUCCO (lbs./MSF) | 1647.05 | 15.68 |
| GAUGING_WATER (lbs./MSF) | 1023.73 | 4.54 |
| FOAM_WATER (lbs./MSF) | 55.18 | 0.46 |
| FOAM_AIR | 10.23 | 0.57 |
| SOAP (lbs./MSF) | 0.21 | 0.02 |
| GROUND GYPSUM | 9.89 | 1.04 |
| ACCELERATOR | | |
| (5% wt. % sugar) (lbs./MSF) | | |
| FLYASH (lbs./MSF) | 7.76 | 0.85 |
| DISPERSANT (lbs./MSF) | 7.91 | 0.83 |
| RETARDER (lbs./MSF) | 0.29 | 0.03 |
| MgO (lbs./MSF) | 2.72 | 0.29 |
| TOTAL_WATER (lbs./MSF) | 1095.31 | 8.20 |
| WATER_STUCCO_RATIO (%) | 66.50 | 0.18 |
| SODIUM TRIMETAPHOSPHATE | 0.935 | 0.01 |
| (dry lbs./MSF) | | |
| SILOXANE (lbs./MSF) | 9 to 10 | |
| BIOCIDE (lbs./MSF) | 1.00 | |

TABLE 3
Skim Coat Operating Parameters

| | | Skim Coat | | Volume (actual |
|---|---|---|---|---|
| | Density | Roller Speed | Rotometer | % of total |
| Product | (lbs/ft³) | (rpm) | H₂O (gpm) | core weight) |
| ⅝″ Type X | 90-92~ | 185-200 | 1.1~ | 13%~ |
| (comparative) | | | | |
| ⅝″ | 87-89~ | 52-57 | 0.5 | 6% |
| ½″ | 87-89~ | 52-57 | 0.5 | 6% |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A mat-faced cementitious composite article comprising:
(a) a cementitious core;
(b) a skim coat cementitious layer in contact with the cementitious core having a density greater than the cementitious core; and
(c) a fibrous mat comprising (i) microfibers and (ii) continuous fibers having a length of about 0.6 cm or more;
wherein the fibrous mat comprises an inner surface facing the skim coat cementitious layer.

2. The mat-faced article of claim 1, wherein both the continuous fibers and the microfibers are glass fibers.

3. The mat-faced article of claim 1, wherein the continuous fibers have a diameter of about 15 microns or more.

4. The mat-faced article of claim 1, wherein the continuous fibers have a diameter of about 15 microns to about 16 microns.

5. The mat-faced article of claim 1, wherein the microfibers have a diameter of about 0.25 microns to about 5 microns.

6. The mat-faced article of claim 1, wherein the microfibers have a diameter of about 2 microns to about 3 microns.

7. The mat-faced article of claim 1, wherein the fibrous mat comprises about 10 to about 30 percent by weight microfibers, and about 70 to about 90 percent by weight continuous fibers having a length of about 0.9-3 cm and a diameter of about 15 microns or more.

8. A method of making a mat-faced cementitious article comprising:
(a) providing a fibrous mat having an inner surface, wherein the fibrous mat comprises (i) microfibers and (ii) continuous fibers having a length of about 0.6 cm or more; (b) depositing an aqueous skim coat layer of cementitious slurry on the inner surface of the first fibrous mat; and
(c) depositing an aqueous cementitious core slurry on top of the skim coat slurry to form a mat-faced composite article.

9. The method of claim 8, further comprising (d) forming the composite article into a board.

10. The method of claim 8, wherein the aqueous skim coat layer of cementitious slurry has a density greater than that of the cementitious core slurry.

11. The method of claim 8 further comprising rolling the skim coat with a skim coat roller prior to depositing the cementitious core slurry, wherein the skim coat roller has a rotational speed of no more than about 130 fpm.

12. The method of claim 11, wherein the skim coat roller has a rotational speed of no more than about 95 fpm.

13. The method of claim 8, wherein the method is performed without the use of vibrational equipment.

14. The method of claim 8, wherein both the continuous fibers and the microfibers are glass fibers.

15. The method of claim 8, wherein the continuous fibers have a diameter of about 15 microns or more.

16. The method of claim 8, wherein the continuous fibers have a diameter of about 15 microns to about 16 microns.

17. The method of claim 8, wherein the microfibers have a diameter of about 0.25 microns to about 5 microns.

18. The method of claim 8, wherein the microfibers have a diameter of about 2 microns to about 3 microns.

19. The method of claim 8, wherein the fibrous mat comprises about 10 to about 30 percent by weight microfibers, and about 70 to about 90 percent by weight continuous fibers having a length of about 0.9-3 cm and a diameter of about 15 microns or more.

20. The method of claim 8, wherein the skim coat slurry has a viscosity sufficient to produce a patty of about 9″ or less as measured by a slump test.
